(19) United States
(12) Patent Application Publication
(10) Pub. No.: US 2014/0198062 A1
(43) Pub. Date: Jul. 17, 2014

(54) Input Element for Operating a Touch-Screen

(71) Applicants: Andre Kreutzer, Mittweida (DE); Karin Weigelt, Chemnitz (DE); Matthias Foerster, Dresden (DE); Jan Thiele, Chemnitz (DE)

(72) Inventors: Andre Kreutzer, Mittweida (DE); Karin Weigelt, Chemnitz (DE); Matthias Foerster, Dresden (DE); Jan Thiele, Chemnitz (DE)

(73) Assignee: PRINTECHNOLOGICS GMBH, Chemnitz (DE)

(21) Appl. No.: 14/002,828

(22) PCT Filed: Mar. 1, 2012
(86) PCT No.: PCT/EP2012/053502

§ 371 Date: Mar. 19, 2014

Related U.S. Application Data
(60) Provisional application No. 61/447,893, filed on Mar. 1, 2011.

(30) Foreign Application Priority Data
Mar. 1, 2011 (EP) 11156481.1
Jun. 7, 2011 (EP) 11168877.6

(51) Int. Cl. G06F 3/041

(52) U.S. Cl. CPC G06F 3/041
USPC 345/173

(57) ABSTRACT

There is described an input element for operating a touch-screen, said input element comprising an electrically conductive layer which is applied to an electrically non-conductive substrate. The electrically conductive layer is structured and has at least one button, conductor track and/or electrode, wherein at least one electrode and/or conductor track is operatively connected to the touch-screen.

The invention relates to an input element for operating a touchscreen, which comprises an electrically nonconductive substrate and an electrically conductive layer applied thereto with at least one key, conductor track and/or electrode, and at least one electrode and/or conductor track is in operative contact with the touchscreen. Furthermore, the invention relates to the use of the input element and to the interconnection of a plurality of input elements to form a keyboard.

Numerous electronic devices are described in the prior art which have a touch-sensitive screen (touchscreen) which can be operated using fingers or input devices. Touchscreens are nowadays in virtually all areas of life. By means of their intuitive operation, they enable, even for the most inexperienced user, easy operation of technical devices in the everyday world and can be used for operating an electronic device. That is to say that, in addition to their use in everyday life, they are also used in industry, where touchscreens are used, for example, for controlling machinery, or in the games industry sector, in which they are used for gaming machines or arcade games. Further examples of touchscreens include smartphones, cellular telephones, displays, tablet PCs, tablet notebooks, touchpad devices, graphics tablets, televisions, PDAs, MP3 players and/or other input devices.

A touchscreen can also be part of input devices. Such input devices are used, inter alia, in smartphones, PDAs, touch displays or notebooks.

In general, a touchscreen, also referred to as a sensor screen, is understood to mean a touch-sensitive layer which is applied to the screen and which responds on contact with a user's finger or a stylus suitable depending on the technology used. The touchscreen is an input device with a direct effect, i.e. the input takes place directly on the indicated space, not away from the display, as would be the case for a mouse or a keyboard, for example. In addition, the positioning with the touchscreen is absolute, i.e. it is not dependent on the previous position. Consequently, touchscreens provide the possibility of extremely intuitive operation, since the screen at the same time acts as a user interface and it is not necessary to choose an indirect route via external input devices.

Most touchscreens can be operated only or preferably using fingers or input devices. That is to say that even complex inputs need to be performed via the screen. For this purpose, symbols, characters or numbers are displayed on the screen, and these need to be touched by a finger in order for an input to be made. Since, however, the space on the screen is limited and often a field to be activated encodes a plurality of characters, inputting mistakes occur. In general, the user is inclined not to use a touchscreen to perform relatively long texts or complex inputs.

The prior art describes input devices, such as keyboards, for example, which are used for the operation of an electronic device. A keyboard generally describes an input device which, inter alia, contains a number of keys to be pressed with fingers as operating element.

For example, a machine, a computer or another apparatus can be operated via the keyboard. The keyboards described in the prior art are based on electronic, mechanical or pneumatic keys, by means of which inputs can be communicated precisely. A keyboard can furthermore be part of a smartphone or cellular telephone. Thus, the keyboard needs to have, in addition to a precise input, a structural design which enables integration in a cellular telephone or smartphone. The prior art describes so-called membrane keyboards which can primarily be used when resistance to dirt and water or easy cleanability is required or when a compact design or inexpensive production is desired. These keyboards are used as the keyboard in computers, machines, medical devices, disinfectable applications or electrical domestic appliances.

The membrane keyboard in principle has a flexible design, as a result of which it can also be used permanently under special use conditions. The surfaces often consist of plastics which usually are thermally deformed and/or have stamped portions. In order to enable precise input, many membrane keyboards have an elastic resilience zone, which enables a key travel of approximately half a millimeter. Otherwise, these keyboards have substantially the same ergonomic performance features which are also used in standard mechanical pushbuttons.

The prior art discloses input devices. For example, WO 2010/026845 A1 describes an input device which is integrated in electronic devices and determines the direction and intensity of an input. The analysis of the input is performed by means of measurements of changes in capacitance when regions of the input device are pressed. The device consists of a resin film, on which a movable electrode and a fixed electrode are arranged. As soon as the movable electrode (or a deformable region thereof) is brought into contact with the fixed electrode, a change in capacitance occurs, which can be measured by an evaluation unit.

Furthermore, US 2010/026635 A1 describes an interactive screen which has marked regions which can be actuated by a user, for example. In this case, the screen can also be built into electronic devices, such as ATMs. A user touches the regions and thus effects a change in the capacitance of the screen, which in turn achieves an input. The touchable regions can also output a feedback to the user in respect of whether the input was successful.

One disadvantage with the input devices disclosed in the prior art consists in that they are not usable universally and as required. Implementation of the devices necessarily involves a complexity in terms of apparatus which completely rules out spontaneous use of the input devices.

Against the background of the prior art, the object of the invention consists in providing an input element which does not have the disadvantages or defects of the prior art and which can be used to operate a touchscreen.

The object is achieved by the independent claims. Advantageous embodiments result from the dependent claims.

It has surprisingly been found that an input element for operating at least one touchscreen can be provided which does not have the disadvantages or defects of the prior art. The input element according to the invention can be connected flexibly to a touchscreen and is universally usable. In addition, it is manufacturer-independent and can thus be used cross-system. The input element can be operatively connected quickly and easily to one or more touchscreens. In addition, it is predestined for mobile use since it is insensitive to acting forces and is transportable owing to its low weight. An input element for operating at least one touchscreen is provided, wherein the input element comprises at least one electrically nonconductive substrate and at least one electrically conductive layer, wherein the electrically conductive layer is present in structured form on the substrate and consists of at least one key, conductor track and/or electrode, and at least one electrode and/or conductor track is operatively connected to the touchscreen.

The electrically conductive layer preferably consists of two, in particular three different functional regions. It is preferred for the electrically conductive layer to comprise at least one electrode, conductor track and/or key. An input element preferably has a multiplicity (more than one, preferably more than five, particularly preferably more than seven) electrodes, conductor tracks and/or keys. The conductor tracks and/or electrodes of an input element can advantageously be connected to one another, with the result that interconnections can be produced.

Within the meaning of the invention, a key refers to in particular an operating element. In a preferred embodiment of the invention, a key can represent the end of a conductor track which is touched by a user. However, it may also be preferred for the keys to have springs or snap-action disks. It is characteristic of keys that it is only possible to detect from an associated effect whether a key has been actuated. Keys are divided into nonelectrical and electrical keys. In the case of the nonelectrical keys, a mechanical mechanism is set in motion by the key, for example, which mechanical mechanism effects a response associated with the key. In the case of electrical keys, an electrical contact is closed by actuation of the key, for example, with the result that an event is initiated in a system associated with the key. In a preferred embodiment of the invention, the input element can have at least one electrical and/or at least one nonelectrical key, wherein snap-action disks can preferably be used in the keys.

The input element preferably has different functional regions. The first region of the input element is an electrode which is formed in particular by the electrically conductive layer on the electrically nonconductive substrate. At least one electrode and/or conductor track is operatively connected to the touchscreen and represents the interface for the touchscreen. Within the meaning of the invention, the electrode or the electrically conductive layer is in particular arranged in the physical vicinity of the touchscreen. Within the meaning of the invention, a physical vicinity or an operative connection relates in particular to the fact that there is a direct contact or an indirect contact and the electrode and/or the conductor track is in functional interaction with the touchscreen.

The second region of the input element is preferably a conductor track, which electrically connects the first and a third region to one another and likewise in particular consists of the electrically conductive layer, i.e. preferably is part of this electrically conductive layer.

The interaction between the electrically conductive layer, namely at least one electrode and/or conductor track and touchscreen, can be achieved by various physical operating principles or combinations thereof, for example capacitively, inductively, electromagnetically or electronically. The respective interaction is dependent on the specific touchscreen type used, i.e. on the touchscreen technology. The function of the electrode and/or the conductor track (i.e. of the electrically conductive layer) is preferably initiation of at least one touch event on the touchscreen. Within the meaning of the invention, a touch event relates in particular to an initiation of an event on the touchscreen. It is known to a person skilled in the art that events can be initiated on a touchscreen by touching. In this case, for example, a user brings one or more fingers into operative contact with the touchscreen, wherein an event (a touch event) is initiated on the touchscreen by the contact. The fingers can also be brought into the physical vicinity or caused to approach the touchscreen, which in turn initiates touch events on the touchscreen. The input element according to the invention likewise generates one or more such touch events by virtue of the electrically conductive layer (i.e. in particular at least one electrode and/or conductor track) being brought into operative contact with the touchscreen. For this purpose, a user can connect the input element, in particular the electrodes and/or conductor tracks, to the touchscreen and perform inputs (i.e. touch events) on the touchscreen via the input element.

In a preferred embodiment, the third region of the input element is a key. It represents the interface to the operator (synonymous with user) and interacts with the input element during use thereof. That is to say that the key can be touched physically by the operator or a user. The key is preferably arranged outside the touchscreen. In its simplest embodiment, the key represents the free end of the conductor track, and in a preferred embodiment the key is applied as a second electrode to the substrate, wherein a first electrode and/or conductor track is in operative contact with the touchscreen.

In a preferred embodiment, the electrode is in direct interaction with the touchscreen, and the conductor track preferably produces the electrical connection between the electrode and a key. It is preferred for the electrode and the conductor track to consist of the same material and thus for it to be possible for them to be produced in the same process step. They then preferably differ in terms of their geometric shape and size. It is also preferred for the conductor track to be implemented in a different material than the electrode. In a further preferred embodiment, the key is operatively connected to the electrode and the touchscreen via a conductor track, with the result that a connection is produced between the operator and the touchscreen.

In a further embodiment, the input element can have a top layer, which covers the electrically conductive layer and/or the substrate. Since the electrically conductive layer is not present over the full area of the substrate, but is only applied to regions of the substrate, the top layer can cover only the substrate, only the electrically conductive layer or both. In a first embodiment, the top layer is preferably manufactured from paper, plastic and/or metal and can be printed or coated with a layer of dye and/or varnish. The top layer can advantageously be an adhesive layer, a paper layer, a layer of dye, a layer of varnish and/or a film. It is naturally also conceivable for combinations of the aforementioned to be applied. In a further preferred embodiment, preferably all electrically nonconductive materials, such as paper, cardboard, wood materials, composite materials, laminates and/or plastics, for example, can preferably be used as substrate of the top layer. The input element can be protected by the top layer from contamination, but also from the external action of forces. Thus, the input element can be transported and shipped easily, for example. It was fully surprising that the electrically conductive layer has an increased electrical stability owing to the top layer and voltage fluctuations substantially do not occur.

In a preferred embodiment, at least one conductor track, electrode and/or key of the input element is connected to a connecting means of a connector. In this case, the connector, which within the meaning of the invention can also be referred to as an interface, plug, connection or connecting device, comprises electrodes, conductor tracks and at least one connecting means. Advantageously, the connecting means has electrical access to the electrodes or conductor tracks of the connector, with the result that an electrical connection to at least one input element can be produced. By virtue of the configuration of the connector, electrical conductivity can be ensured. This is advantageous when, in a preferred embodiment, a further input element or an input device is connected to the connector.

It was entirely surprising that the input element can be connected easily to the connector and, as a result, the functionality and usability of the input element is considerably extended. It may be preferable for a first input element to be operatively connected to a touchscreen and, in addition, to be in contact with electrodes of a second or further input element or input device via conductor tracks or electrodes. As a result, a series circuit comprising a plurality of series-connected input elements or input devices is realized, wherein the connector acts as a connecting device of the first input element with respect to a further input element or input device.

In a preferred embodiment, the connector is part of the first input element. It may also be preferable for the connector to be connectable reversibly to the input element and to be configured as a disposable article. The connector preferably comprises at least one connecting means, which can produce the connection with the first or second input element. In this case, it may be a receiving apparatus, such as a slot or shaft, for example, or a rest, into which the input element can be inserted or on which the input element can be fitted.

In addition, it is preferred for the connector to be connectable to further input devices or input elements. That is to say that the connector is preferably connected to a first input element, which in turn is operatively connected to the touchscreen. In addition, a further input element or an input device can be connected to the connector, with which input device an input can be implemented on the touchscreen via the first input element. The further input element or input device is preferably connected to the connector via a connecting means. The connector enables a quick and simple connection of the further input element or input device to the first input element, which is operatively connected to the touchscreen. It was fully surprising that the connector can be regarded as a universal interface which is compatible with input devices of different shapes. It may be advantageous to consider the connector as a type of “established/standardized” interface.

Within the meaning of the invention, input devices refer in particular to means via which an input can be made on an electronic device. Examples of input devices include, for example, pointing devices (mouse, touchpad or joystick), keyboards or graphics tablets, digital pens, gamepads, scanners or speech input systems. A person skilled in the art is aware what is included under the term “input device” within the meaning of the invention. The input devices can likewise be connected to the connector by means of connecting means. These connecting means are, by way of example and without any restriction being imposed thereby, connecting devices typical in the prior art such as male connectors, female connectors, cables, terminals, pliers, butt connectors, soldering connectors, ribbon cables, female multipoint connectors and male multipoint connectors, multiple socket outlet strips, spring contacts or exposed areas consisting of a conductive material. By means of the connecting means, the electrodes with the associated conductor tracks of the connector are connected to the conductor tracks and/or keys of the input element, with the result that an electrical connection exists between the two.

Owing to the combination of the technical features, an input element can be provided with which simple and convenient operation of a touchscreen is achieved. It is possible for complex, but also simple inputs to be implemented via the keys of the input element which are connected to the screen. The keys of the input element are preferably larger than the input fields on the touchscreen, with the result that small input fields on the touchscreen can be operated by means of large keys, which simplifies the inputting procedure substantially. In particular for people with impaired vision, the input element can be advantageous. The keys of the input element can be equipped with tactile elements, as a result of which touchscreens for people with impaired vision can be used. Furthermore, characters on the keys of the input element can be represented in enlarged form in order to simplify identification of the keys, for example by older people. In this regard, it may be advantageous if a special input device is connected to the input element and the touchscreen via the connector, which in particular enables inputting by people with impaired vision. This may be, for example, a speech input system or a keyboard with enlarged keys which are simply connected to the connector.

It is preferred for the substrate of the input element to be selected from the group consisting of plastic, paper, cardboard, wood material, film, composite material, glass, ceramic, textiles, leather or a combination thereof. It was fully surprising that the substrate can in particular be an electrically nonconductive layer (for example a layer of dye or varnish) which can likewise act as intermediate layer or separating layer. The substrate can preferably electrically insulate regions of the electrically conductive layer from one another, with the result that multilayered input elements can also be realized, in which the electrically conductive layer is printed onto the separating layer or intermediate layer. The substrate is in particular an electrically nonconductive material which is preferably flexible and has a low weight. Transparent or non-transparent substrates can be used. It was surprising that such a substrate can be used to provide an input element with which a touchscreen can be operated. An essential advantage of the preferred substrate consists in that it has a low weight and is transportable.

An electrically conductive layer is applied to the substrate, wherein the layer is preferably present as an area on regions of the substrate. The shape of the area is as desired and can have various embodiments. Thus, for example, round, angular or oval areas or combinations can be present on the substrate. It is also possible for complex geometric shapes to be realized or for a plurality of individual areas to be combined with one another. In addition, it may be preferred for a plurality of electrically conductive areas to be applied to a substrate. Advantageously, the shape, orientation, number, alignment, distance and/or position of the areas can vary.

The area can be even or uneven, for example raised, positively stamped or subjected to thermal compression or depressed or negatively stamped, which considerably simplifies operation or actuation of the input element since, for example, a clear position on the key can be assigned for a finger. Advantageously, the electrically conductive layer and/or the top layer can be even or uneven. Thus, a tactile or haptic perception of the key is possible. It may also be preferred for tactile or haptic elements to be applied to the top layer or the electrically conductive layer in order to improve perception. It is further possible to implement the key with additional elements, such as spacers, snap-action disks, tactile elements or other variants known from keyboards or switches, for example. A key is in particular an operating element which is actuated by touch, preferably pressing.

The keys can advantageously be supplemented by one or more LEDs, with the result that it is possible to identify not only from an action whether they have been actuated, but also from an optical signal. That is to say that, in a preferred embodiment, at least one LED can be connected to the key and can reproduce the state of the key. In addition, it is also preferred for the input element to have acoustic means (for example loudspeakers) which give feedback on an action implemented by a user to the user via an acoustic signal.

The electrically conductive layer is preferably a metal layer, a layer containing metal particles, a layer containing electrically conductive particles, an electrically conductive polymer layer or a layer consisting of at least one combination of these layers. In general, any material which is electrically conductive can be used. Furthermore, metalorganic materials, consisting of a compound of metal and carbon, can also be used. Within the meaning of the invention, metals refer in particular to chemical elements which, in contrast to the non-metals, are found in the periodic table to the left of the diagonal separation line beginning with the element beryllium (group 2) up to polonium (group 16), and the alloys and intermetallic compounds (including Laves phases, Heusler phases, Zintl phases, Hume-Rothery phases, NiTi, Co5, Nb3Sn or Ni3Al) thereof with characteristic metallic properties. Metals include, inter alia, aluminum, lead, chromium, iron, gold, indium, cobalt, copper, magnesium, manganese, molybdenum, sodium, nickel, silver, titanium, tungsten, zinc or tin.

Furthermore, metal oxides such as, for example, indium tin oxide can be used. This is particularly advantageous because, although it is electrically conductive, it is also transparent. Therefore, an input element can be provided which preferably consists of a transparent substrate, a transparent electrically conductive layer and possibly a transparent top layer, with the result that no area on the touchscreen is optically covered by the input element when it is in operative contact with the touchscreen.

Within the meaning of the invention, polymers refer in particular to a substance which is composed of a collection of macromolecules (polymer molecules) with a chemically uniform structure but which generally differ in terms of degree of polymerization, molar mass and chain length. The polymers are preferably electrically conductive. In the case of such materials with polymer unity, all of the macromolecules preferably have the same structure and differ only in terms of their chain length (degree of polymerization). Such polymers can be referred to as polymer homologs. Polymers can be selected from the group consisting of inorganic polymers, metalorganic polymers, fully or partially aromatic polymers, homopolymers, copolymers, biopolymers, chemically modified polymers and/or synthetic polymers. Particularly preferably, polymers are selected from the group consisting of paraphenylene, polyacetylene, polypyrrole, polythiophene, polyaniline (PANI) and PEDOT.

Furthermore, electrically conductive substances are in particular carbon black or graphite particles. Carbon black describes an allotrope of carbon which forms on incomplete combustion or thermal cleavage of vaporous carbon-containing substances. Carbon black can be used in powder or granulated form. It is also possible to use carbon black preparations, for example, in the form of liquid, paste or solid carbon black/solvent concentrates, in which the carbon black is dispersed uniformly. Depending on the production process used and the raw material, carbon black can contain hydrogen, nitrogen or oxygen, in addition to carbon. Carbon black has an excellent pigment property and insolubility in all solvents, resistance to most chemicals, lightfastness, and good color depth and color strength. Within the meaning of the invention, graphite refers in particular to a stable modification of carbon. Owing to a layered structure, graphite is a good conductor.

The electrically conductive layer is preferably applied in structured form to the substrate. Within the meaning of the invention, structured refers in particular to the fact that the electrically conductive layer does not cover the substrate completely, but partially, i.e. regionally. It is preferred for the substrate to have regions which are not covered by the electrically conductive layer. By linking the electrical conductivity with the structured application, it has surprisingly been possible to achieve targeted interaction between the input element and the touchscreen.

It is preferable for the electrically nonconductive substrate to be fastened on the touchscreen with a form-fitting and/or cohesive connection. The preferred fastening of the input element makes it possible for the electrodes of the input element to be in contact with the touchscreen or to at least physically approach the touchscreen, which permits interaction with the touchscreen. The form-fitting and/or cohesive connection to the touchscreen is preferably reversible. That is to say that the state prior to the production of the connection can be reproduced without the input element or the touchscreen or the surrounding environment thereof being subject to permanent changes. It can also be preferred for the input element, in particular the substrate, to be fastened on the touchscreen in accordance with the adhesive label principle (for example post-it notes) or other adhesives. The three preferred regions of the input element (key, conductor tracks and/or electrode) advantageously consist of the same or a similar electrically conductive material.

It is further preferred for further means for temporarily or permanently fixing the input element on the touchscreen to be used. It was surprising that, for this, substantially all forms of adhesive (electrically conductive and electrically nonconductive) or glues, gums, bands, insertion aids, clamps etc. can be used. This enables a stable contact between the input element and the touchscreen, with the result that sliding or displacement is minimized. In addition, it was surprising that typical device housings and protective sleeves can be connected to the input element and can produce an operative contact between the input element and the touchscreen. It is preferable that all technically relevant methods for the cohesive or form-fitting fixing of the input element on the touchscreen can be used. Advantageously, at least two input elements can be operatively connected to a touchscreen. In addition, it can be preferred for at least one input element to be connected to at least one, preferably two touchscreens. It is thus surprisingly possible to use one input element to operate a plurality of touchscreens.

Since the electrically conductive layers present on the substrate preferably consist of the same or a similar electrically conductive material, advantageously only one technological method can be used to produce these regions at the same time. As a result, the input element can easily and economically be realized as a mass-produced product.

It was surprising that the structuring of the electrically conductive layer on the electrically nonconductive substrate can be realized with a multiplicity of technological methods. This includes, for example, additive methods such as printing methods, stamping methods, PVD and CVD methods, galvanic methods and subtractive methods such as laser structuring, brush methods, milling methods, etc. Naturally, semi-additive methods such as etching methods, for example, can also be used.

In this regard, it was fully surprising that the input element can be produced by a transfer method in a preferred embodiment. It is preferred for the electrically conductive layer to be applied to the substrate by a transfer foil method, particularly preferably by a cold-foil transfer method. Such methods are known to a person skilled in the art. It is of course also possible for all other methods for structured application of an electrically conductive layer to be used.

The device containing the touchscreen is preferably selected from the group consisting of smartphones, cellular telephones, displays, tablet PCs, tablet notebooks, touchpad devices, graphics tablets, televisions, PDAs, MP3 players and input devices. A touchscreen can also be part of input devices, for example. Within the meaning of the invention, a touchscreen can also be referred to as a sensor screen. Such input devices are used, inter alia, in smartphones, PDAs, touch displays or notebooks.

A capacitive touchscreen described in the prior art is a glass substrate or plastic coated with transparent metal oxide (for example ITO—owing to the scarcity of the element indium, substances such as ITO are very expensive, and therefore there are already approaches for replacing ITO with less expensive transparent but electrically conductive materials). Owing to a voltage applied to the corners of the coating, a constant, uniform electrical field is generated and a low level of charge transfer is produced, which can be measured in the discharge cycle in the form of a current at the corners. The resulting currents from the corners are in a direct relationship with respect to a touch position and are processed correspondingly by a controller. A further implementation of a capacitive touchscreen uses two planes consisting of conductive strips, which are arranged orthogonally with respect to one another. One plane acts as sensor, and the other performs the task of the driver. If a finger is located at the intersection point between both strips, the capacitance of the capacitor changes and a changed and/or detuned signal is registered at the receiver strip.

It was entirely surprising that the input element can be used for a multiplicity of different touchscreens. Tests have shown that in particular capacitive touchscreens are particularly well suited. In this case, preferably at least one input element is connected to the touchscreen, wherein the substrate of the input element is attached on the, close to the, or not on the device comprising the touchscreen.

It is preferred if the substrate of the input element at least regionally does not rest on the device or the screen. The fastening of the substrate on the touchscreen can preferably be performed by means of a reversible cohesive connection. As a result, quick fastening and removal of the substrate is possible. Within the meaning of the invention, cohesive connections refer in particular to connections in which the connection partners are held together by atomic or molecular forces and include, for example, adhesive bonding or adhesive strips. Advantageously, that region of the substrate which is connected to the touchscreen is adhesive, as a result of which optimum fastening to the touchscreen can be produced.

In addition, the invention relates to a keyboard comprising at least two input elements, wherein the at least two input elements are operatively connected to a touchscreen via in each case at least one conductor track and in each case at least one electrode and/or conductor track. The input elements are arranged with respect to one another in such a way that a preferably complete keyboard layout is implemented. For this, the input elements can be arranged so as to overlap one another, for example. In a further embodiment of the invention, the input elements can also be arranged in such a way that the input elements are located on one or at least two substrates, which are arranged so as to overlap one another at least regionally, and a multilayered keyboard is realized. In addition, it is preferred if the input elements have an identical substrate or different substrates, which are arranged so as to overlap one another at least regionally. Within the meaning of the invention, overlapping one another regionally refers in particular to the fact that at least part of an input element (for example electrically conductive layer and/or substrate) is overlapping with at least part of a further input element. As a result, a complex multilayered keyboard can be provided in which complex conductor track runs can be realized. Surprisingly, any short circuits between electrical layers can thus be avoided. It may be preferable for the substrates to be connected by means of cohesive or form-fitting connections, wherein the substrates can also be attached directly to the touchscreen via such connections.

Advantageously, the design of the input elements corresponds to an arrangement of keys, a set of conductor tracks and an arrangement of electrodes, wherein the electrodes are particularly preferably in the form of areas which are preferably identified by the touchscreen as finger input. In a preferred embodiment, the arrangement of keys corresponds to the keys on a keyboard, and the arrangement of electrodes corresponds to an arrangement of touch areas, which preferably makes it possible to operate a virtual keyboard on a touchscreen. That is to say that the input element is preferably configured in such a way that the layout of the keys is similar to a keyboard layout known to a person skilled in the art. Such layouts are known to the user, and therefore he knows where the keys are arranged, which considerably simplifies operability. The symbols corresponding to a keyboard can preferably be pressed on the top surface (synonymous with top layer). In a further embodiment, in combination with software development, freely configurable touch surfaces or regions on the touchscreen can be realized which initiate a certain action.

As soon as a user touches or approaches the electrically conductive layer applied to the substrate in the region of the key with a finger, an electrical capacitance of the user is conducted from the electrically conductive key via the conductor track or tracks to the electrodes and therefore to the touchscreen. The touch by the user projected in this way on the touchscreen can advantageously call up actions or implement inputs. Within the meaning of the invention, operatively connected refers in particular to the fact that the input element is connected or linked to the touch-sensitive region of the touchscreen in such a way that an event or an effect is initiated on the touchscreen by an operator of the key via the conductor track and/or the electrode. Examples of operatively connected elements are, for example, an incandescent bulb and a light switch, which are connected to one another via an operation or function. In the simplest sense, operatively connected means in particular that something is connected mechanically to one another at least temporarily. Furthermore, it can be connected, for example electronically, in such a way that energy and/or information are transmitted (for example without a mechanical connection being present); i.e. two elements are arranged or linked (to one another) in such a way that the desired effect is achieved. The key is brought into contact with the touchscreen via the conductor track, and then the electrode of the input element. Within the meaning of the invention, bringing into contact means that in particular there is preferably no free space between the electrode of the input element and the touch-sensitive region of the touchscreen. That is to say that the electrode is preferably in touching contact with the touchscreen. However, it can also be preferred for there to be no direct contact between the electrode of the input element and the touchscreen, but only for an approach to be made, which is sufficient for initiating an event or an action. This is in particular the case when intermediate layers and/or substrates prevent direct contact between the electrode and the touchscreen. This is dependent on the design of the input element itself and the way in which it is fixed on the touchscreen.

Advantageously, a plurality of input elements can be used in combination, in particular next to one another and/or one above the other and/or temporally successively by the touchscreen or by the electronic device having the touchscreen, wherein in particular each key of the input element is preferably connected to at least one electrode via at least one conductor track, which electrode is in turn in preferred contact with the touchscreen.

It was surprising that the usability of existing touchscreens (for example for cellular telephones or tablet computers) is markedly improved. The input field on a touchscreen which is too small can be enlarged as desired and matched in terms of layout and user preferences. Furthermore, the keys of the input element can be positioned as desired and are not assigned to a vicinity with respect to the touchscreen. In addition, advertising and/or additional information can be attached or applied to the input elements or the keyboard. Preferably, advertising and additional information are applied to the rear side or the top layers. This results in additional advertising and marketing area and naturally a forum for this which until now has been unique.

The invention also relates to the use of at least one input element in particular as keyboard for operating a touchscreen. The abovementioned embodiments with respect to the input element apply similarly to the use of the input element as keyboard. Multiple uses of the input element are preferred. These include, for example, applications in the advertising and marketing sector, wherein the input element can be used as a brochure or flyer. Particularly advantageous is the use in direct connection with virtual items or else in the download sector for music, videos, text, data or E-books or else for bonus marks or corresponding programs.

It was entirely surprising that at least one input element can in particular be used as keyboard for operating a touchscreen. By virtue of the preferred use of the input element, preferably an event is initiated on the device carrying the touchscreen by means of the interaction between the electrode and/or conductor track of the input element and the touchscreen. The event advantageously in turn initiates actions, such as the activation and/or ending of an application, the changing of numerical values and/or texts, the manipulation of graphics, the changing of databases or the gaining of access to information technology services, without this being restrictive.

It is preferred that the input element is used in such a way that at least one key of the input element is assigned to at least one data set in a data processing system and the data set remains constant. In a further embodiment, at least one key is assigned to one or more data sets. In a preferred embodiment, at least one key is assigned to a data set or a plurality of data sets in a data processing system, wherein the data set or data sets is/are changed. This can take place, for example, using the key and/or over time. Advantageously, at least one key can be used such that it, in conjunction with a touchscreen, can be assigned to an action of a data processing system via the conductor track or initiates such an action. This action applies in particular to non-networked data processing systems and particularly preferably to networked data processing systems.

In addition, the invention relates to a kit for operating a touchscreen, comprising an input element and a connector, wherein the input element can be operatively connected to the touchscreen. As illustrated above, the input element comprises an electrically conductive layer, which is arranged on an electrically nonconductive substrate. The electrically conductive layer preferably consists of at least one electrode, key and/or conductor track, wherein in particular at least one electrode and/or conductor track is operatively connected to a touchscreen. The input element can preferably be connected to a connector. The kit enables simple operation of a touchscreen and can be produced as a mass-produced product. It may also be advantageous if the kit is offered for sale as a disposable article.

Furthermore, it is preferred if the kit additionally comprises a further input element and/or an input device, wherein the further input element or the input device is connected to the connector. That is to say that it is preferred if a first input element is operatively connected to the touchscreen, and a connector is connected to the first input element. The connector can be considered to be a universal interface which enables the connection of a second (further) input element or an input device. By virtue of the fact that there is an electrical line between the individual components, operation of the touchscreen can take place with the further input element or input device. It was entirely surprising that an input device (such as a keyboard, for example) can be connected to the connector, with which input device, in turn, the operation of the touchscreen is ensured via the first input element. According to the invention, such a connection can in particular be referred to as an operative connection. The embodiments relating to the input element can be applied analogously to the kit.

The invention will now be described with reference to figures by way of example using an embodiment, but without being restricted to this embodiment; in the figures:

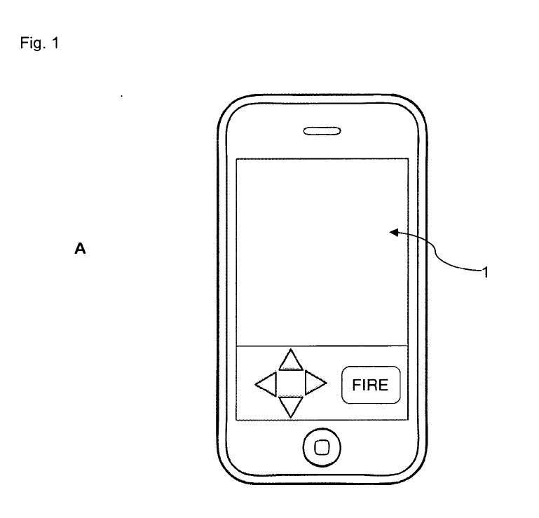

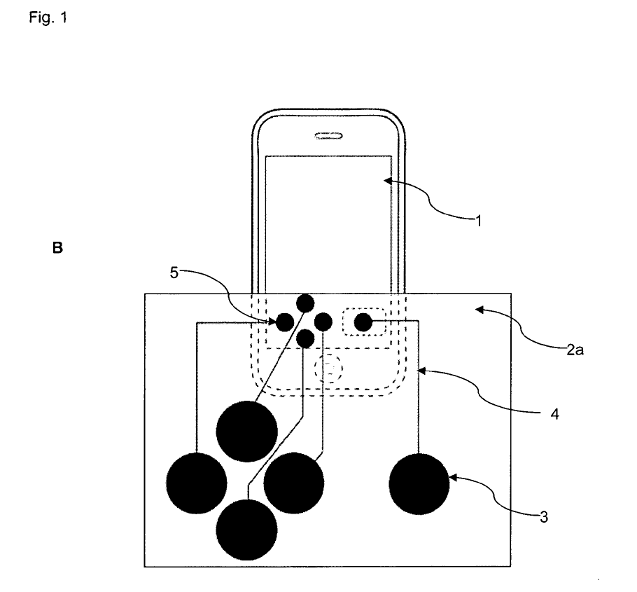

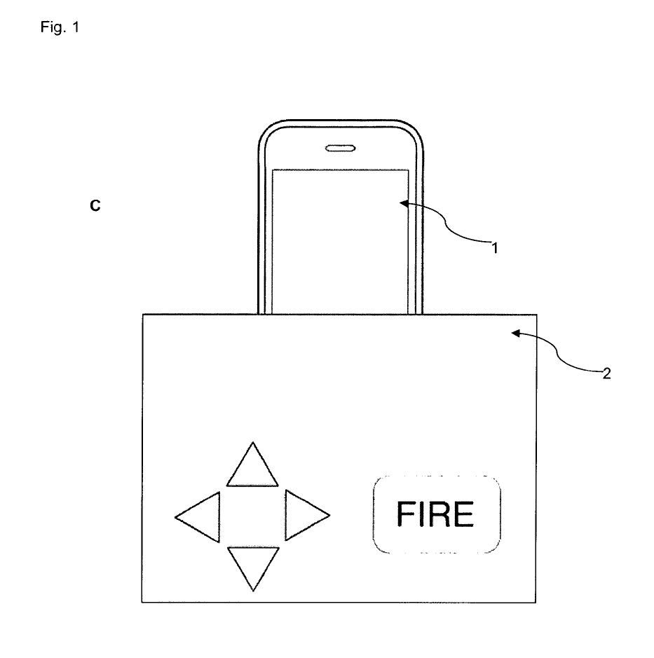

FIGS. 1A-C show an example of a games application

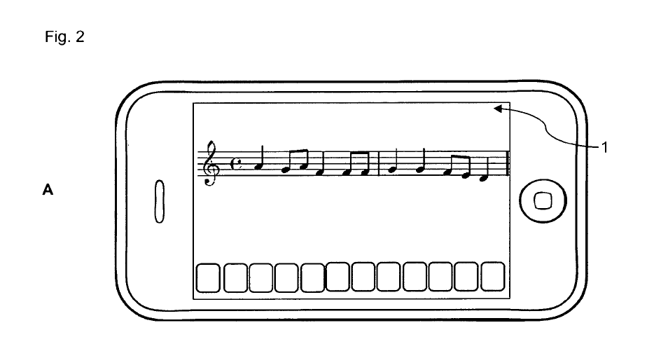

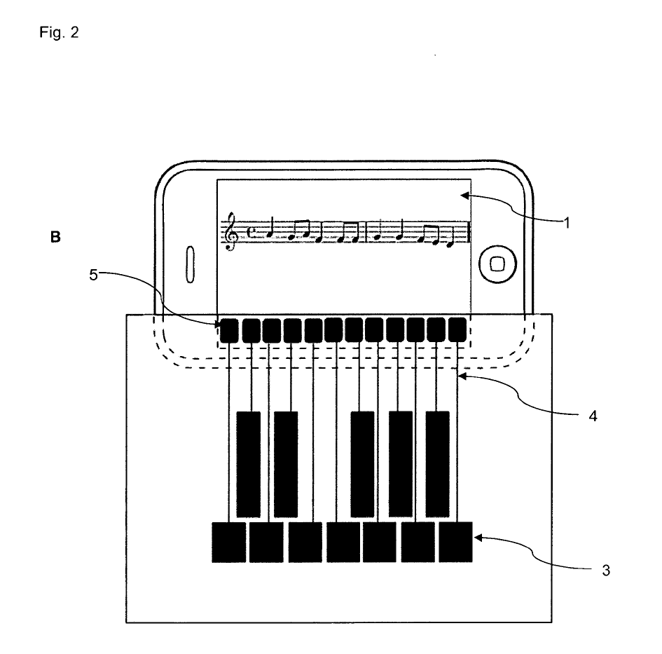

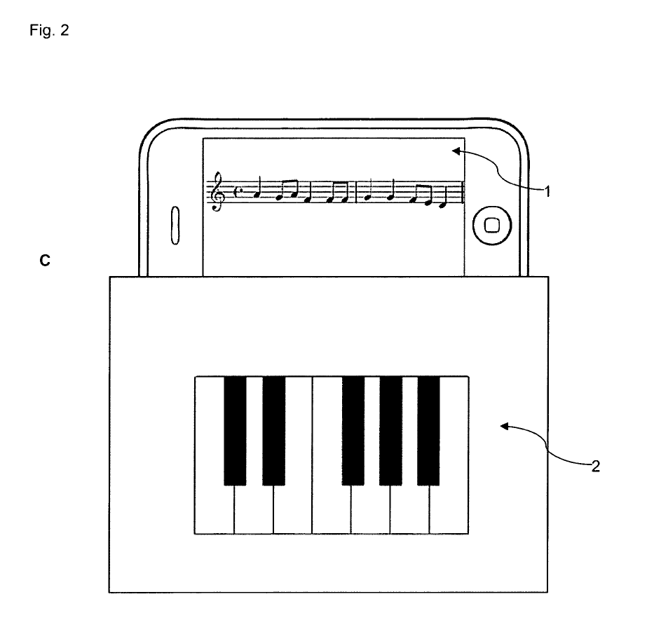

FIGS. 2A-C show an example of a keyboard application

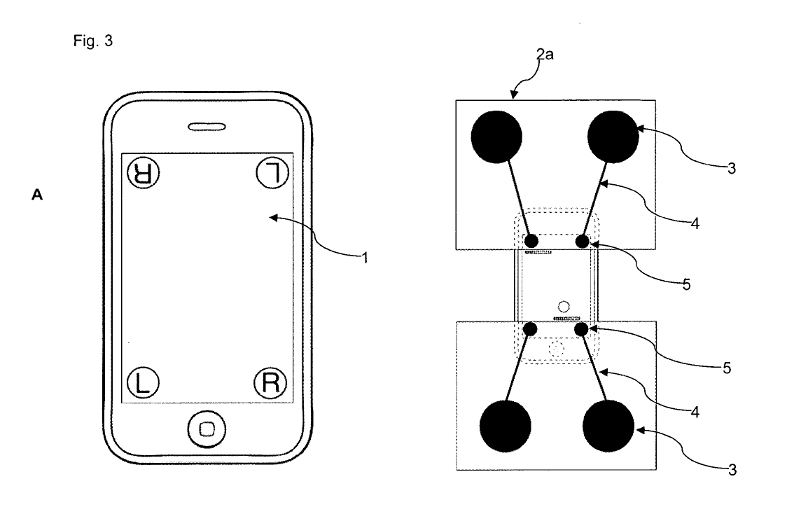

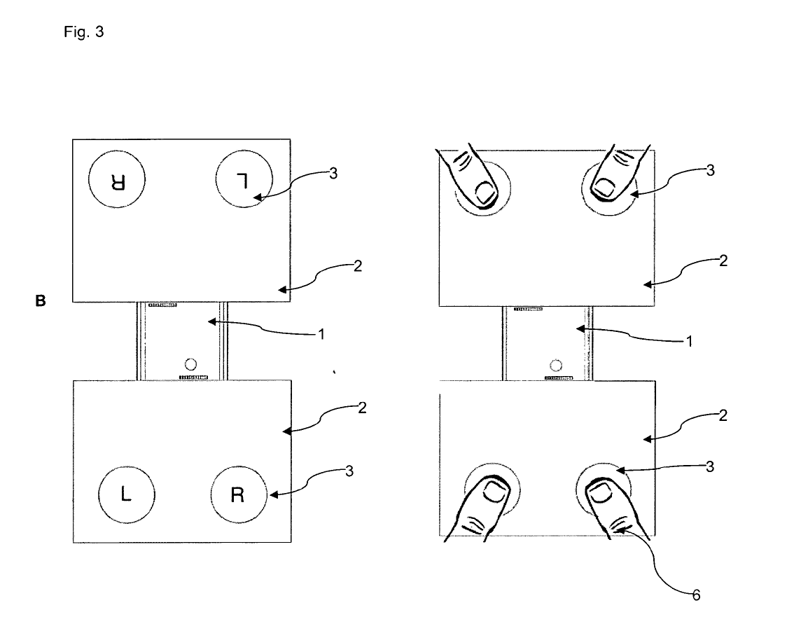

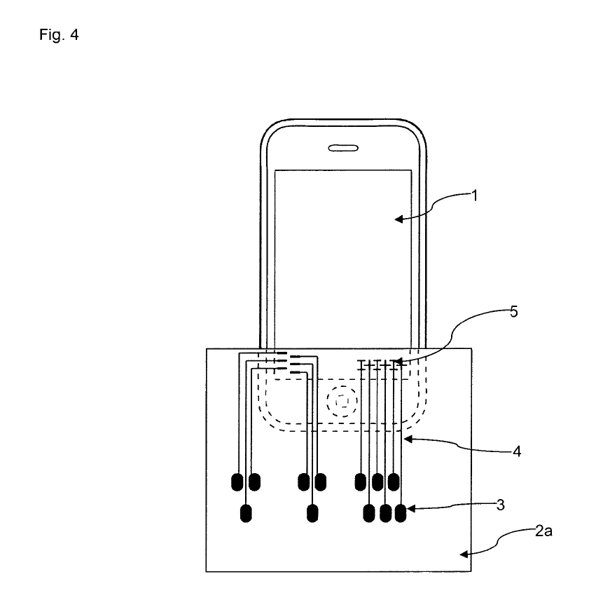

FIGS. 3A-B show a further games application

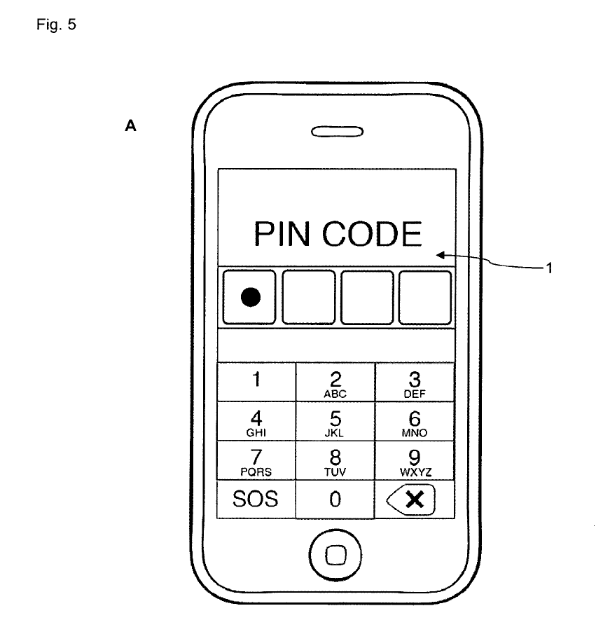

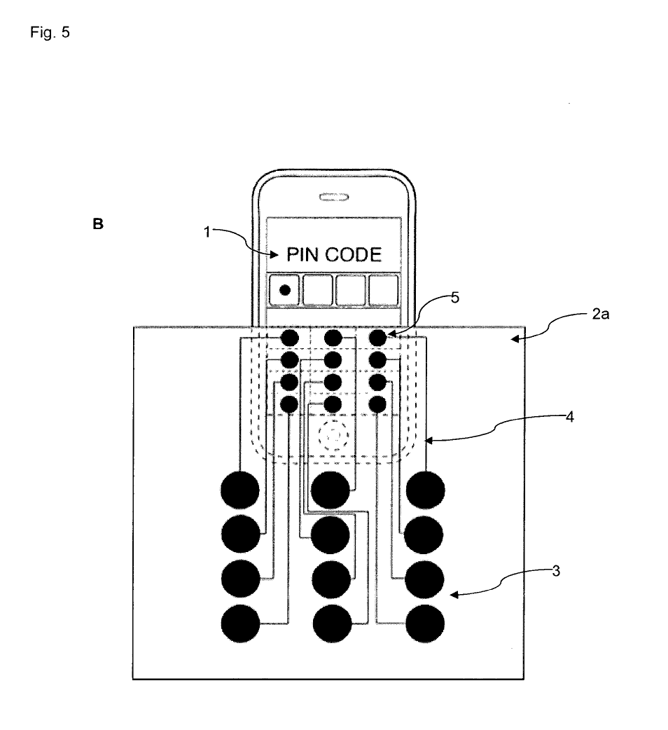

FIG. 4 shows exemplary embodiments of the electrodes

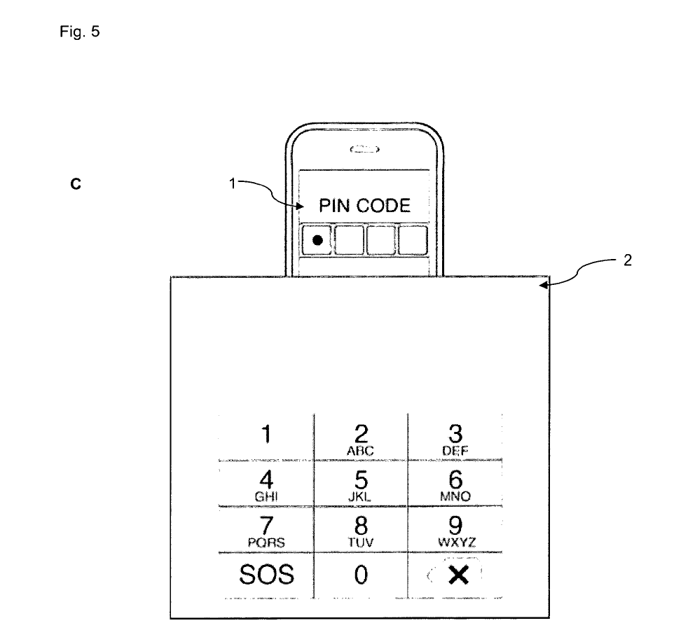

FIGS. 5A-C show the use of the keyboard for inputting a PIN

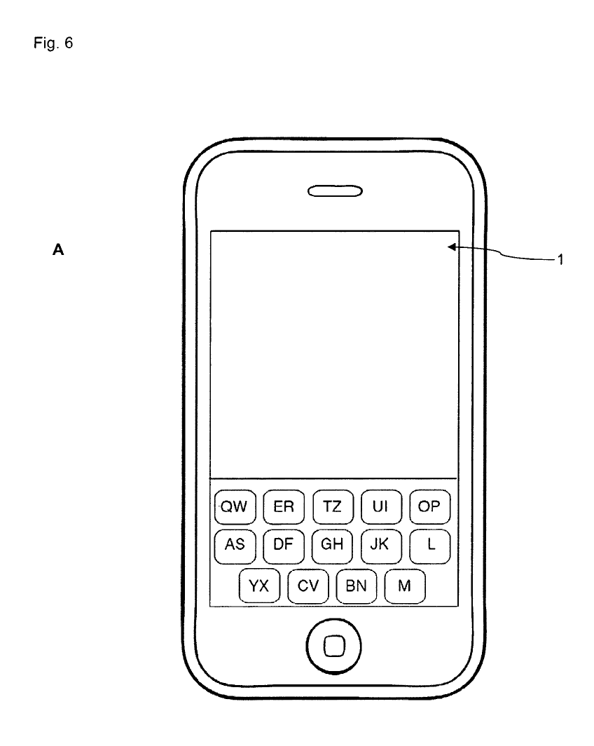

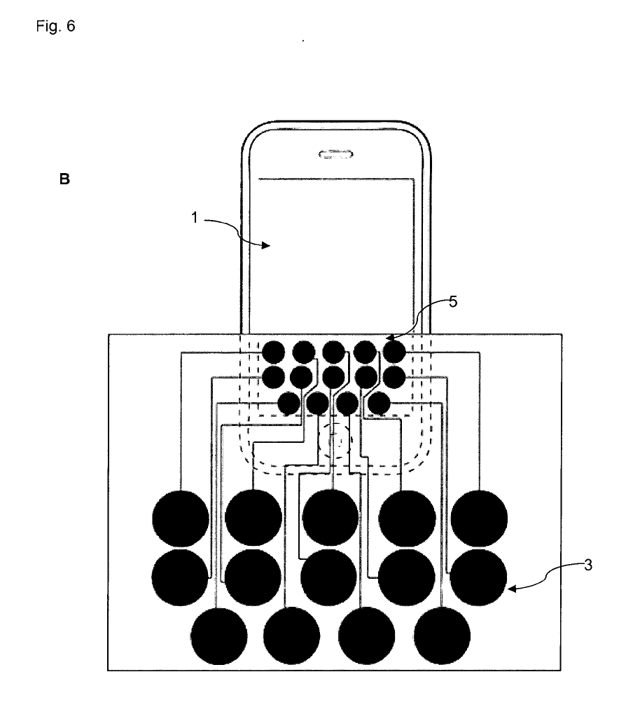

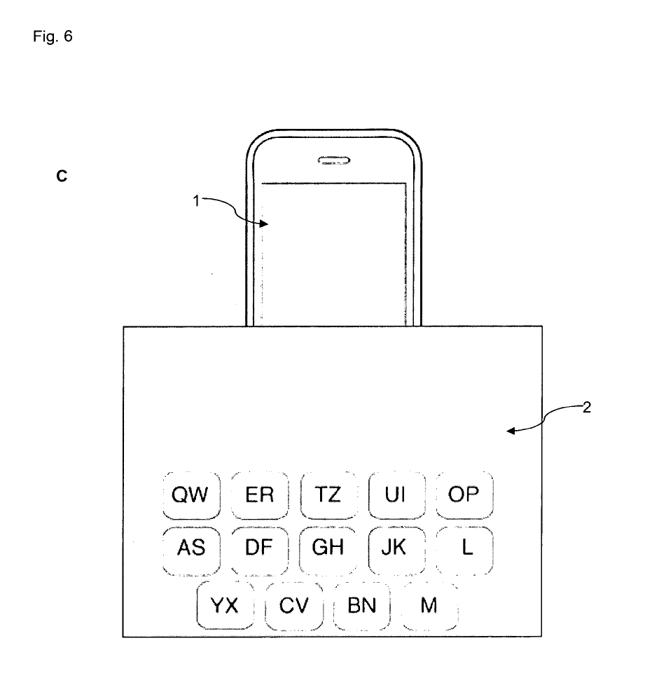

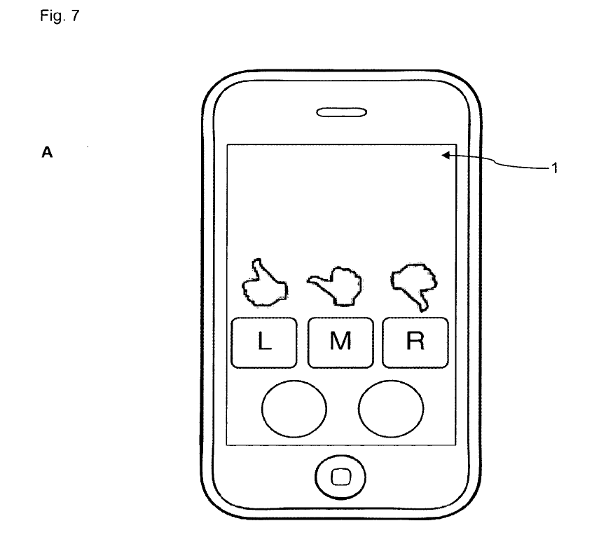

FIGS. 6A-C show a keyboard with few or double-assigned keys

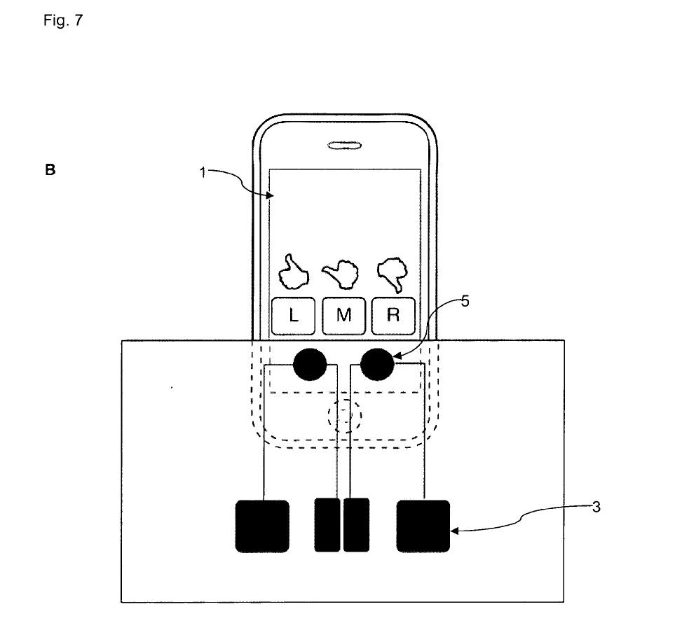

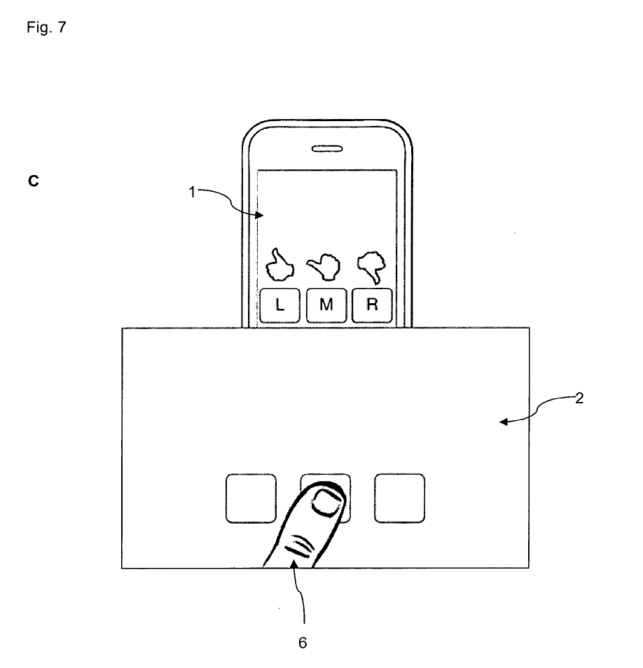

FIGS. 7A-C show a touchscreen interface with two touch surfaces which act as input points

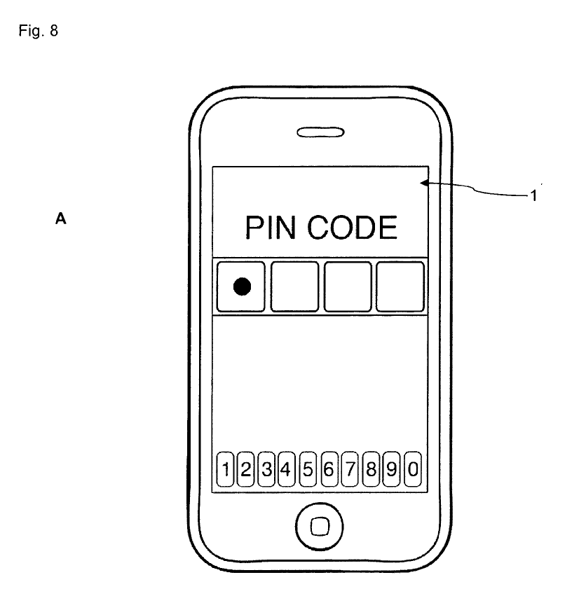

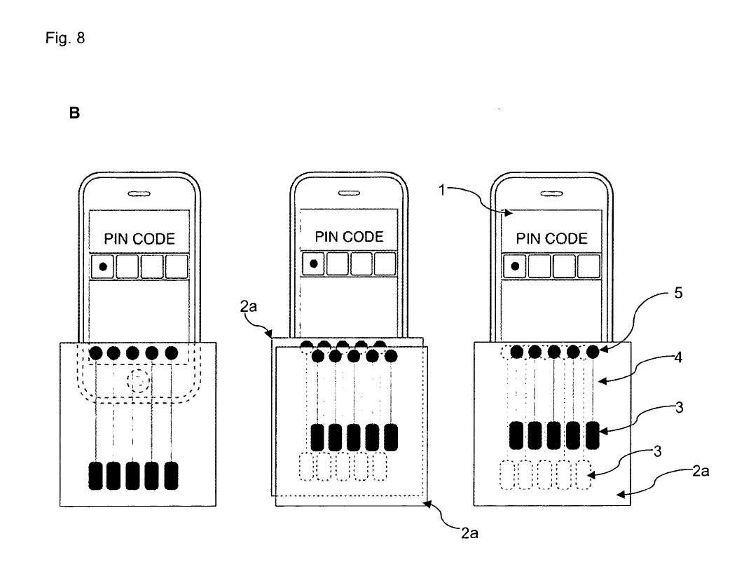

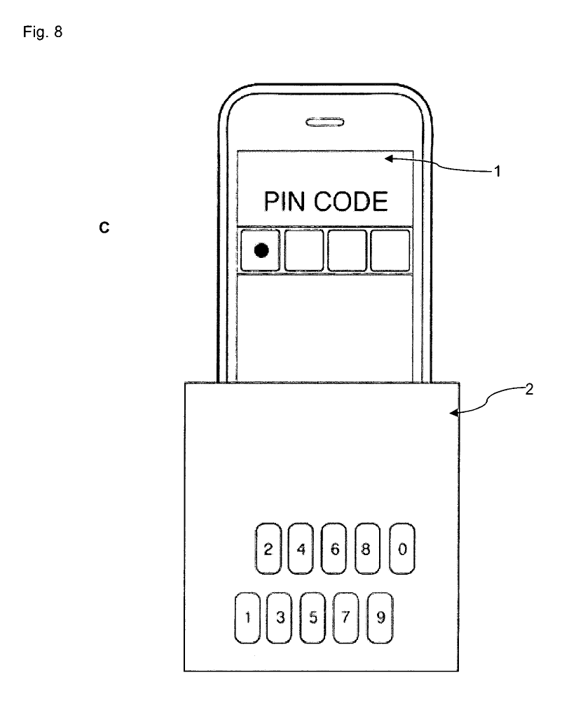

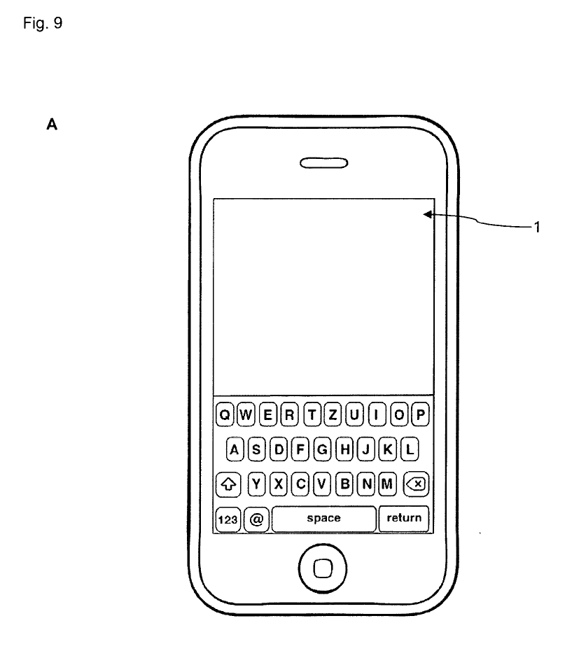

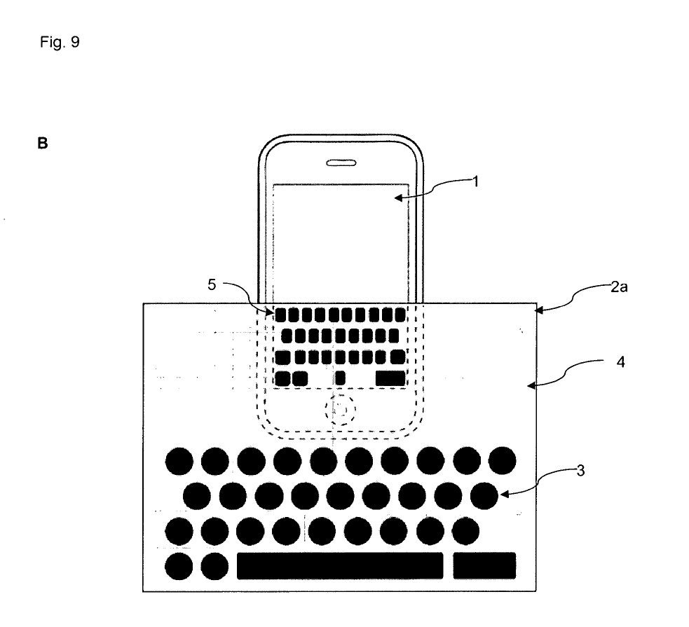

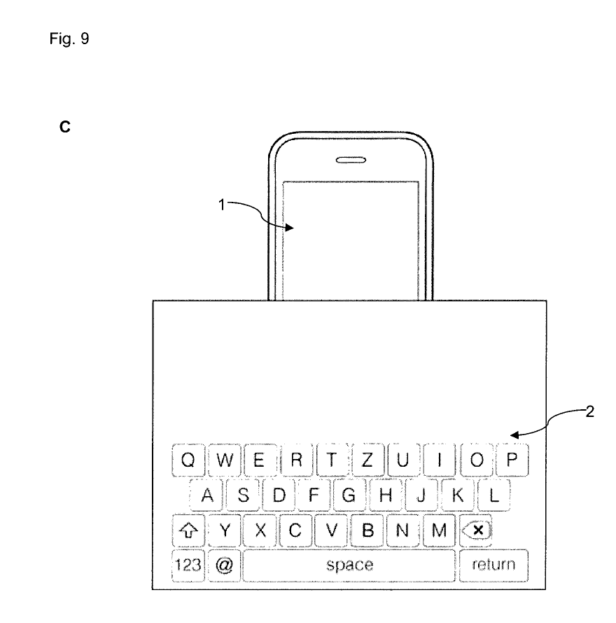

FIGS. 8A-C show an embodiment of the keyboard as a multilayered keyboard FIGS. 9A-C show a multilayered keyboard

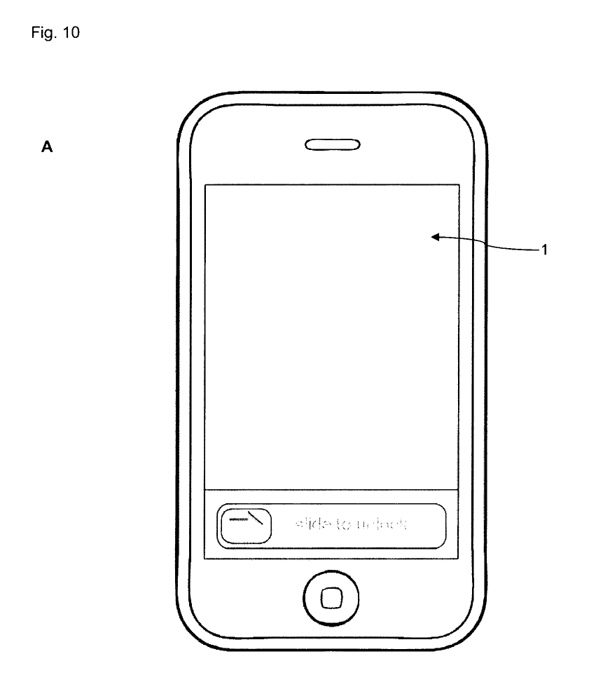

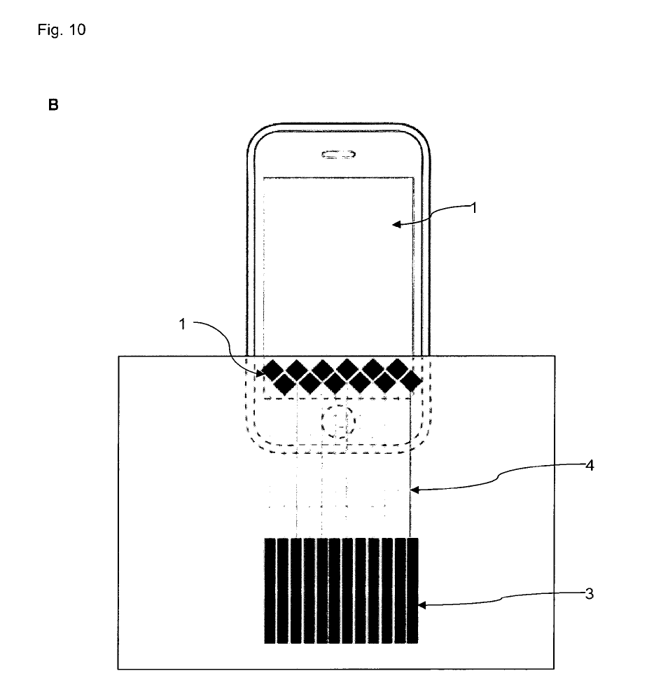

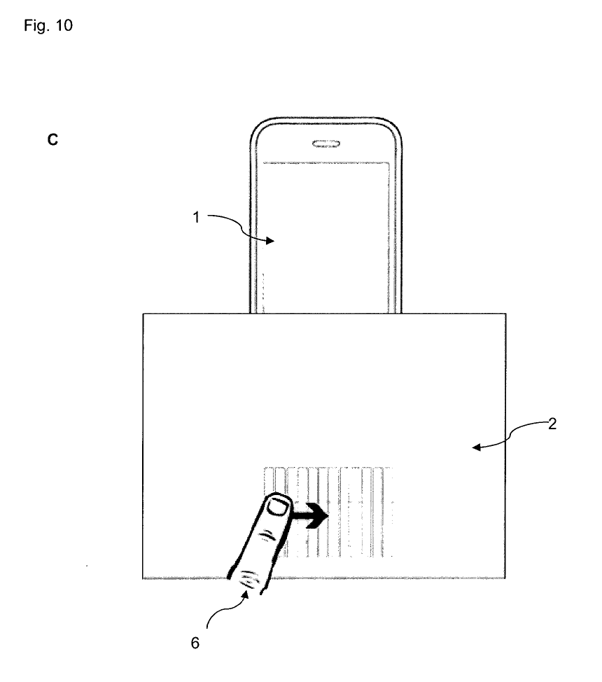

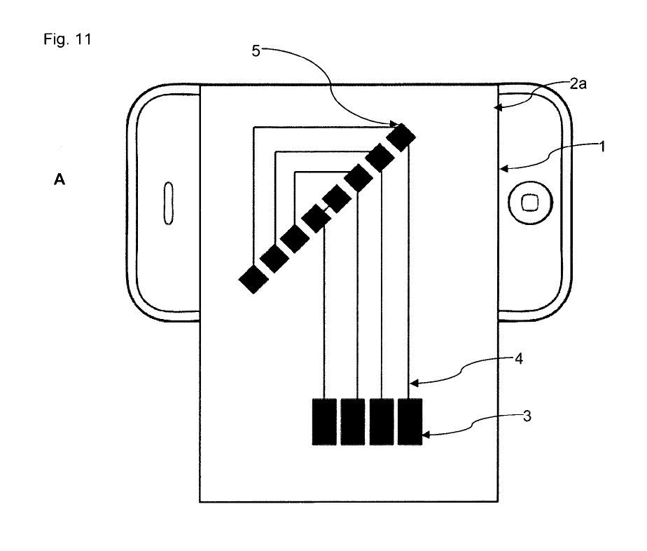

FIGS. 10A-C show a projected dynamic input command

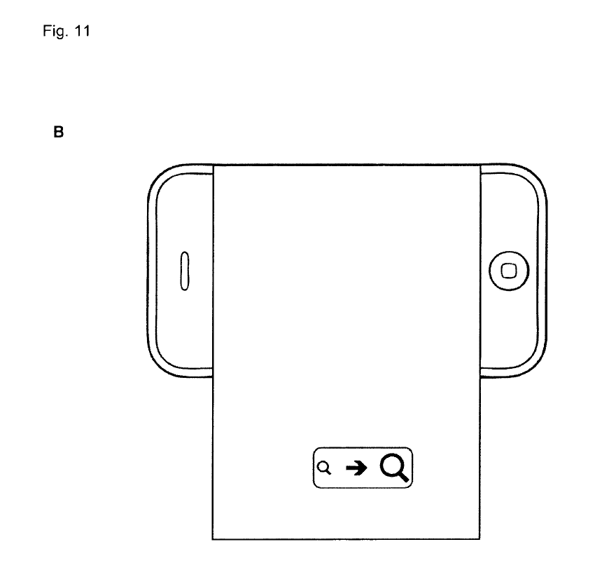

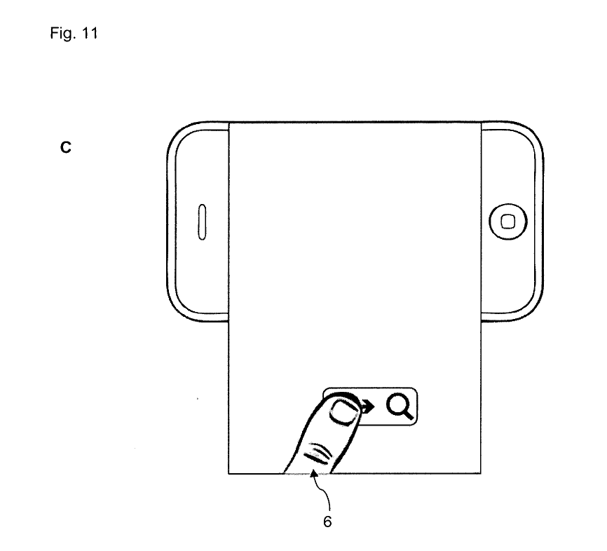

FIGS. 11A-C show a further example of a dynamic input

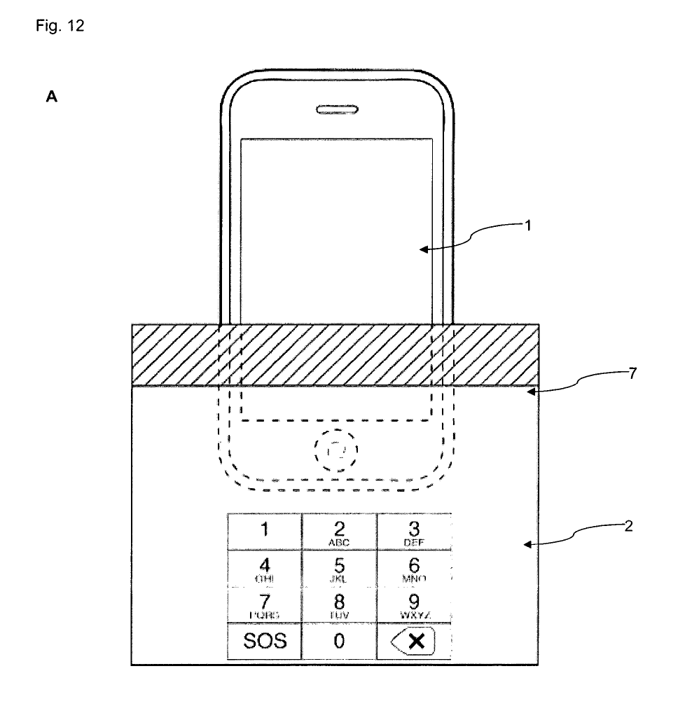

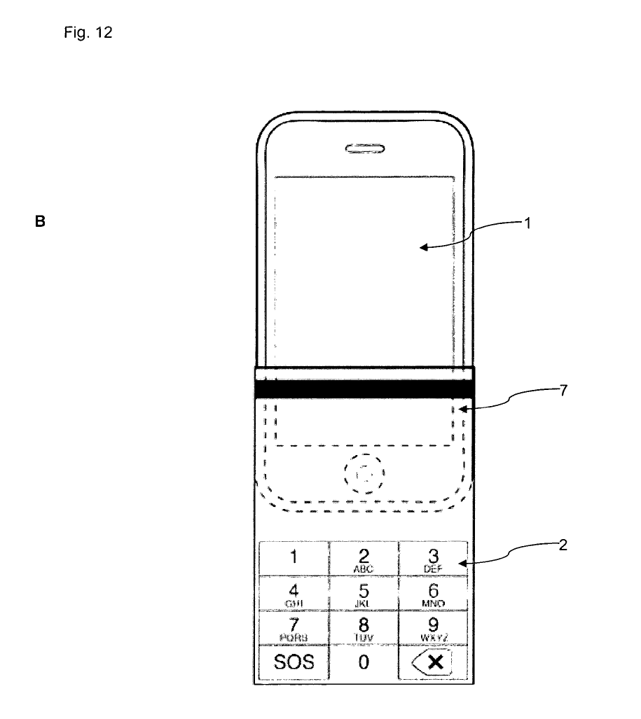

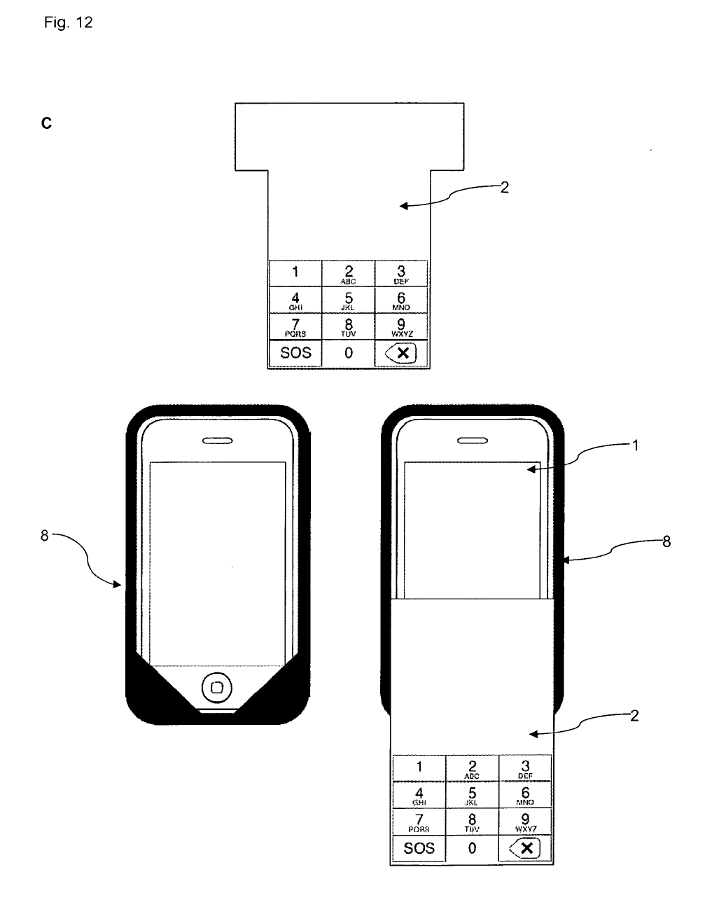

FIGS. 12A-C show connection possibilities

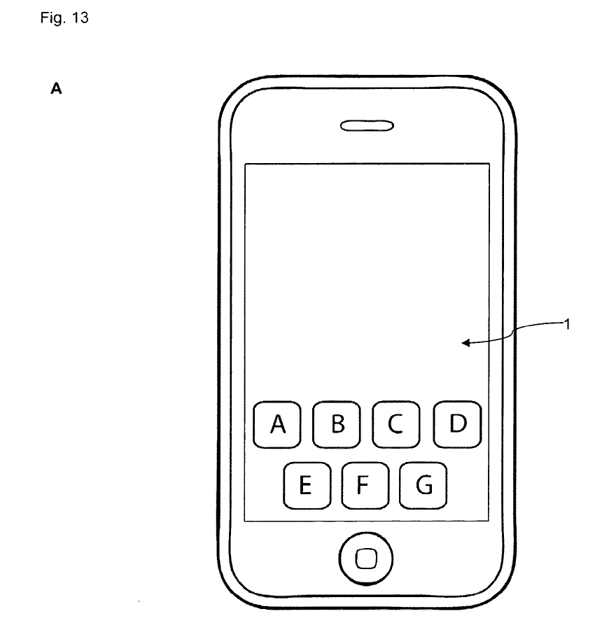

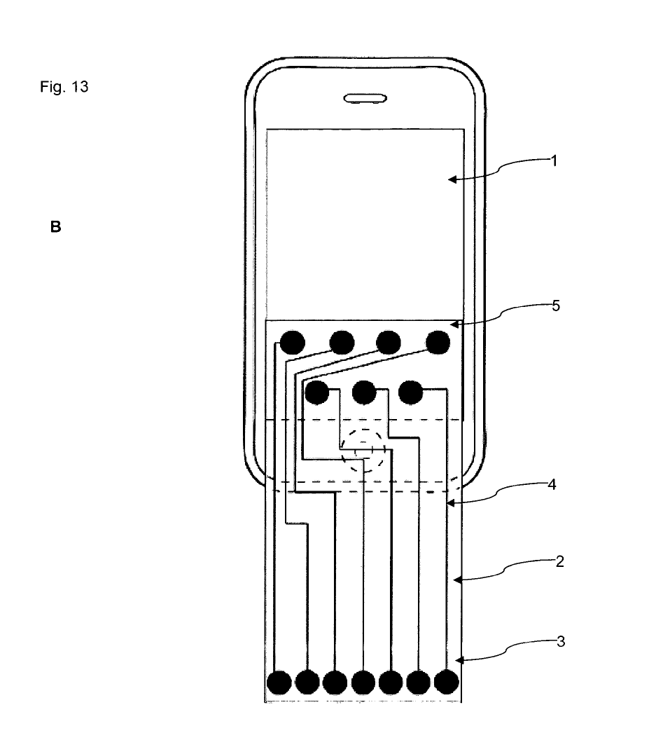

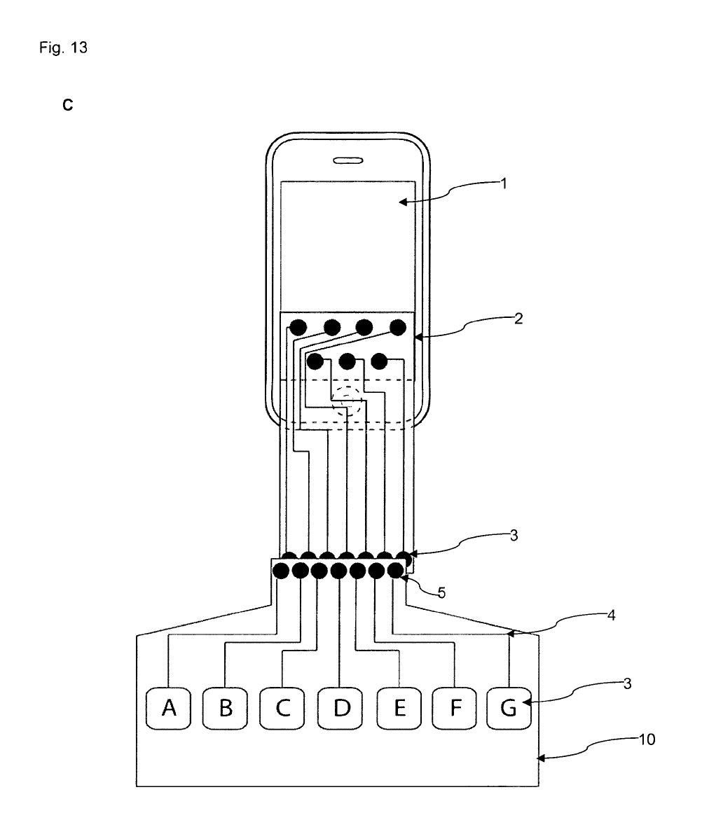

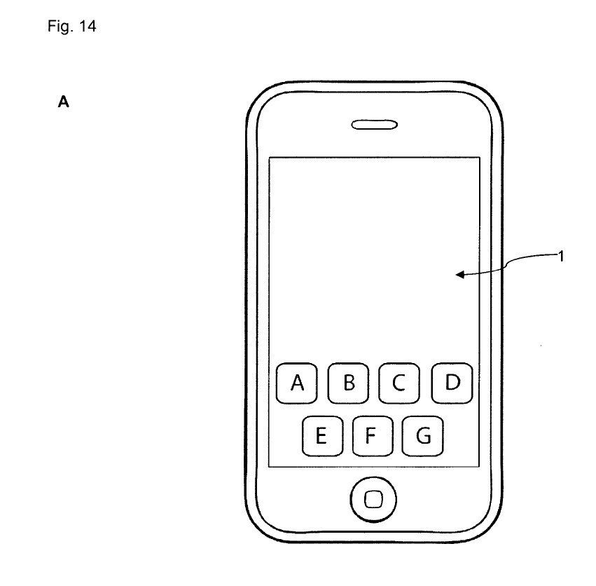

FIGS. 13A-C show an example of a connection of a plurality of input elements

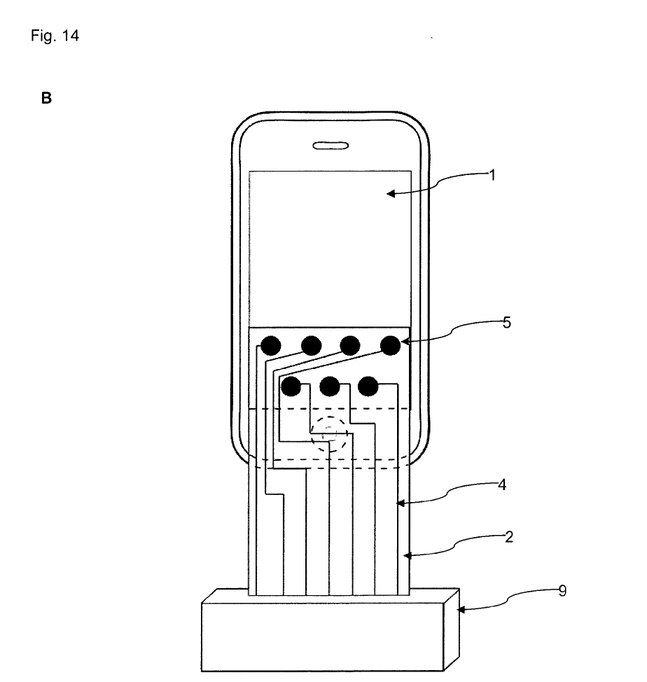

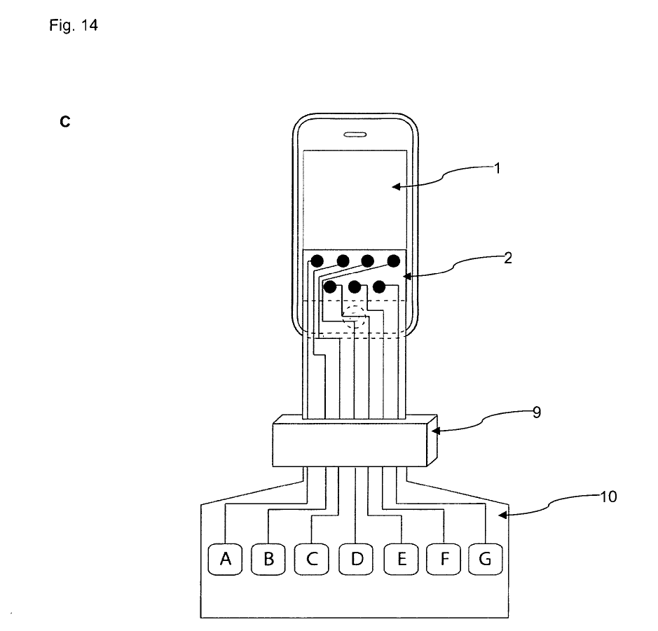

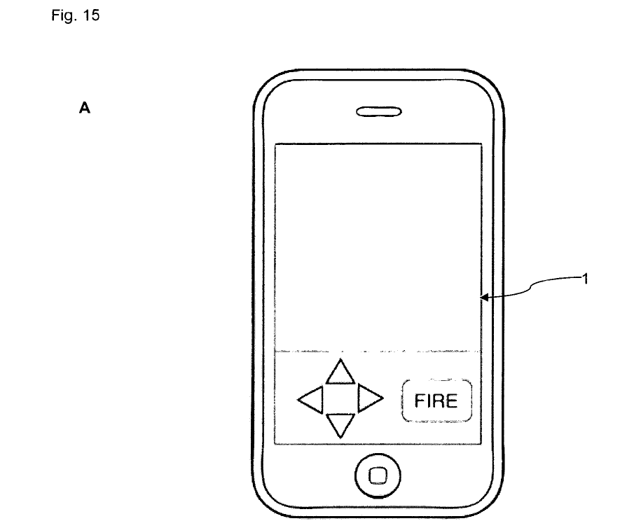

FIGS. 14A-C show a connection of an input element to a connector

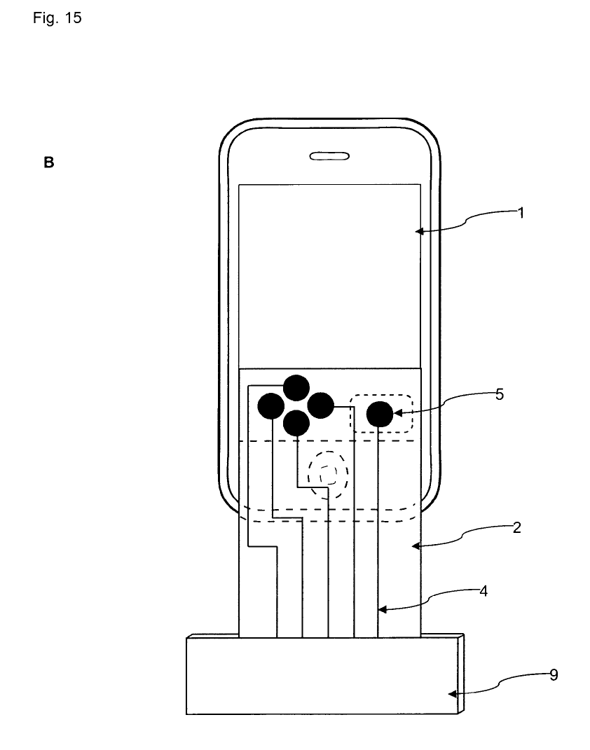

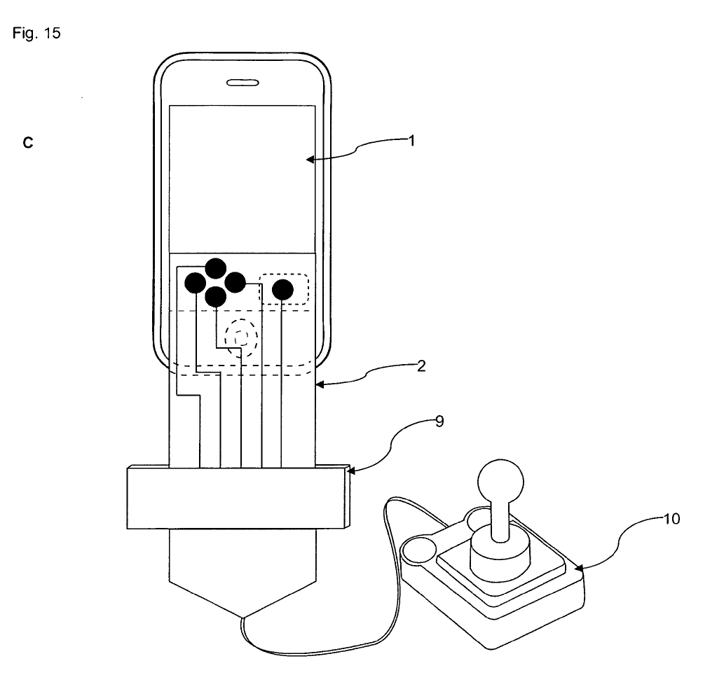

FIGS. 15A-C show a further example of a connection via a connector.

FIGS. 1A-C show an example of a games application. A plurality of input elements, comprising key 3, conductor runs 4 and/or electrodes 5, are connected together to form a keyboard 2, which can be configured such that, by virtue of the operative connection, regions on the touchscreen 1 can be actuated which are intended for a games application. The input element 2 preferably comprises conductor runs 4, keys 3 and electrodes 5, which are arranged as electrically conductive layer on an electrically nonconductive substrate 2a. In this case, there is contact between the electrodes 5 of the input element 2 and a cursor field on the touchscreen 1, by means of which a game can be controlled via keys 3. For example, four directions plus one action key can be activatable.

FIGS. 2A-C show a preferred application of the keyboard in the form of a keyboard application in the form of a piano. The keyboard 2 is configured in such a way that piano keys on a touchscreen 1 can be activated or actuated via the keys 3, conductor runs or tracks 4 and electrodes 5.

FIGS. 3A-B show a further games application. Two keyboards 2 can be laid or fastened on a touchscreen 1, with the result that two people can play a game on opposite sides, for example. The input elements 2 comprise electrodes 5, conductor runs 4 and keys 3, which are arranged on a substrate 2a, wherein the electrodes 5 are in operative contact with the touchscreen 1. In addition, it may be advantageous for the conductor tracks (synonymous with conductor runs) 4 to be in operative contact with the touchscreen 1. For example, two keys 3 can be actuated by in each case one player/user 6, wherein single-touch and multitouch inputs are possible.

FIG. 4 shows further exemplary embodiments of the electrodes. By this means, surface area can be saved and possibly a relatively large region of the touchscreen can be left free. The conductor runs 4, keys 3 and electrodes 5 are arranged offset on the substrate 2a of the input element 2.

FIGS. 5A-C show a preferred use of the keyboard for inputting a PIN. The keyboard 2 can be connected to the touchscreen 1 via an adhesive strip, for example. A user operates the electrically conductive keys 3 on the substrate 2a, which keys are operatively connected to the touchscreen 1 via conductor tracks 4 and/or electrodes 5. Thus, the keyboard 2 can be used, for example, also for inputting a PIN via a touchscreen 1.

FIGS. 6A-C show a keyboard with partially double-sided keys. A keyboard 2 can advantageously be provided with several or few keys. In this case, the actuation of a multiply assigned key 3 can initiate an input according to the first letter on the touchscreen 1. An input program (software) in the background searches for the most probable words on the basis of the input in a dictionary (for example also T9 input aid). As a result, a small keyboard with full functionality can be realized.

FIGS. 7A-C show a touchscreen interface with two touch surfaces, which act as input points. FIG. 7A shows the touchscreen interface on a touchscreen 1 with two touch surfaces which act as input points. FIG. 7B shows a plurality of input elements as keyboard 2, with two electrodes 5 fitted over the two input points. As a result, the keyboard 2 is operatively connected to the touchscreen 1 via the electrodes 5, wherein the electrodes 5, which are connected to the screen 1, are implemented as a round surface. Advantageously, the size of the electrode surface corresponds to a region on the screen 1, which can initiate an action or an event. Advantageously, the keys 3 can also be embodied (see central key) such that, when the central key is touched or approached by a user 6, a multitouch event is initiated (at least two points at the same time), while the two other keys 3 or keyboard points (on the left and right) initiate only a single touch.

FIGS. 8A-C show the embodiment of the keyboard as a multilayered keyboard. The conductive layer with its three preferred regions is distributed over two substrate planes 2a. This enables overlapping of the regions since said regions are separated from one another by an electrically nonconductive layer (for example separating layer), as a result of which a short circuit does not occur. The advantage here consists in that a high packing density can be realized on the touchscreen and also very complex and ramified keyboards 2 are possible. The input element 2 comprises in particular two substrate layers 2a, on which in each case conductor tracks 4, electrodes 5 and keys 3 are arranged. An intermediate layer therefore acts in particular as substrate 2a for a further electrically conductive layer or separates two substrates 2a from one another.

FIGS. 9A-C show the simplified illustration of a complete keyboard layout as a multilayered keyboard. In order to provide complex keyboards 2, the electrically conductive surfaces can be applied to different substrate layers 2a (for simplification all of the electrically conductive regions are at the front), wherein these are preferably separated by nonconductive layers. The respective electrically conductive keys 3 are connected via conductor tracks 4 to regions to be activated, the electrodes 5, on the touchscreen 1. It is thus possible for complex keyboards 2 to be provided which can activate numerous characters.

FIGS. 10A-C show a projection of a dynamic input command. It is advantageously also possible to simulate a dynamic movement or gesture by means of the keyboard 2. In this case, a plurality of keys 3 are arranged one behind the other and are actuated in a fluid movement by a user 6. That is to say that the user 6 preferably moves his finger over the keys 3 of the input element 2, with the result that, via the conductor tracks 4 and electrodes 5, a sequence of touch events is initiated on the touchscreen 1 and the dynamic input is interpreted by the touchscreen 1. It is thus possible for a dynamic input command to be implemented, such as a gesture, for example. It is known to a person skilled in the art that a single touch, multitouch or gestures can be implemented on a touchscreen 1. Gestures include, for example, slide-to-unlock gestures, scrolling, pinch-to-zoom, inputting of symbols such as check marks or question marks.

FIGS. 11A-C show a dynamic input via a keyboard. A dynamic input can be made with the aid of the keyboard 2. It is also possible for a two-finger zoom to be implemented using the input element 2, in which a plurality of electrically conductive layers or surfaces is implemented by a simple operation with a finger which moves from left to right over the zoom button. In this case, a user 6 runs a finger through a sequence of keys 3 on the input element 2, which are in turn connected electrically to electrodes 5 via conductor tracks 4, which electrodes are in operative contact with the touchscreen 1. The figures also show that an interconnection of a plurality of electrically conductive electrodes 5 on the substrate 2a is possible and, as a result, short conduction paths are achieved. In the specific example, only one conductor track 4 leads from in each case one key 3 to an electrode 5, from where in turn a further conductor track 4 leads to a further electrode 5. As a result, a plurality of electrodes 5 can be driven simultaneously, wherein a movement with a finger on the keyboard 2 in one direction is performed and, as a result, a zoom is achieved. It is thus possible to implement a two-dimensional movement on the touchscreen 1 with a one-dimensional movement. In addition, even more complex gestures can be simplified.

FIGS. 12A-C show various connection possibilities for attaching the input element to a touchscreen. Figures A-C illustrate merely by way of example how the input element 2 can be attached to the touchscreen 1, wherein the previously illustrated input elements 2 can also be connected similarly or identically to the touchscreen 1. The input element 2 (for example the substrate 2a) can be attached with a fastening means 7, for example a cohesive or form-fitting connection, on the touchscreen 1 or a housing 8 or jacket 8 accommodating the touchscreen 1. FIG. 12A shows, by way of example, how a connection by means of a fastening means 7 such as a bonding agent (for example adhesive) or an adhesive label principle is produced. The connection is preferably reversible and can be removed after use quickly and easily without backing material remaining or damage to the input element 2 or the touchscreen 1. Furthermore, rubber bands can be used as fastening means 7 for producing a connection, as is illustrated by way of example in FIG. 12B. The input element can likewise be connected to the touchscreen 1 by means of a sleeve, housing, cladding, cover, cellular phone shell or frame 8 (FIG. 12C). Substantially, the input element 2 can be attached to the touchscreen 1 or an article 8 which accommodates the touchscreen. In this case, the input element 2 is preferably configured in such a way that it can be fastened in or on the sleeve 8 of the device having the touchscreen 1. In order to improve the connection, folds can be provided in the input element 2, which make it possible to bend the element at predetermined points.

FIGS. 13A-C show an example of a connection of a plurality of input elements. The ends of the conductor tracks 4 of the input element 2 preferably act as connection point for a further input element 10. Accordingly, within the meaning of the invention, an operative connection between the further input element 10 via the first input element 2 and the touchscreen 1 is produced. The electrodes 5 or ends of the conductor runs 3 of the first input element 2 can be designed in such a way that they act as a universal interface for the connection of further input elements 10.

FIGS. 14A-C show an exemplary connection of an input element to a connector. The input element 2 can have a multi-part configuration and can comprise a connector 9, which enables simple connection of a further input element or input device 10. The connector 9 preferably has a, preferably two, connection points via which a connection to the first input element 2 and a further input element or input device 10 can be produced. This may be, for example, an accommodating apparatus such as a shaft or a slot, into which the input element 2 and the further input element or input device 10 is inserted or is pluggable via male connectors. However, it can also be advantageous to use another connection technique known to a person skilled in the art in order to connect the first input element 2 and the further input element or input device 10 to the connector 9. The connector 9 can therefore be considered to be a universal means of connecting further input elements or input devices 10 such as keyboards or number pads for operating a touchscreen 2.

FIGS. 15A-C show a connector as a universal interface. Further electronic input devices 10, such as joysticks, gamepads, games controllers or keyboards, for example, can be used in addition to an input element 2 for touchscreens 1 via the connector 9. The connector 9 therefore enables a universal interface which can be realized easily for operating a touchscreen 1.

### LIST OF REFERENCE SYMBOLS

1 Touchscreen
2 Input element/keyboard
2a Substrate
3 Keys/ends of a conductor run
4 Conductor runs
5 Electrodes
6 User
7 Fastening means
8 Article accommodating touchscreen
9 Connector
   10 Input device/further input element

1. An input element for operating at least one touchscreen the input element comprising:
at least one electrically nonconductive substrate, and
at least one electrically conductive layer, wherein the electrically conductive layer is present in structured form on the substrate and comprises at least one key, at least one conductor track and/or at least one electrode, and wherein the at least one electrode and/or the at least one conductor track is operatively connected to the touchscreen.

2. The input element as claimed in claim 1, wherein the at least one electrode and the at least one conductor track are connected to one another.

3. The input element as claimed in claim 1, wherein the input element is connected to the touchscreen using a form-fitting and/or cohesive connection.

4. The input element as claimed in claim 1, wherein the input element is a first input element in combination with a second input element, and where in the first and second input elements are operatively connected to the touchscreen.

5. The input element as claimed in claim 1, wherein the input element has a top layer.

6. The input element as claimed in claim 1, wherein the input element is produced by an additive method, wherein the additive method is a printing method.

7. The input element as claimed in claim 1, wherein the electrically conductive layer and/or the top layer has an uneven configuration.

8. The input element as claimed in claim 1, wherein the at least one conductor track, the at least one electrode and/or the at least one key of the input element is connected to a connector.

9. A keyboard comprising the first and second input elements as claimed in claim 4, wherein each of the first and second input elements is operatively connected to the touchscreen via a respective conductor track and a respective electrode.

10. The keyboard as claimed in claim 9, wherein the input elements have or different substrates, which are arranged so as to at least regionally overlap one another.

11. A method for operating at least one touchscreen, the method comprising an act of:
using an input element to provide a keyboard for operating a touchscreen, the input element comprising:
at least one electrically nonconductive substrate, and
at least one electrically conductive layer, wherein the electrically conductive layer is present in structured form on the substrate and comprises at least one key, at least one conductor track and/or at least one electrode, and wherein the at least one electrode and/or the at least one conductor track is operatively connected to the touchscreen.

12. The method as claimed in claim 11, wherein the act of using the input element to provide a keyboard comprises using the input element to initiate an event on a computing device via the touchscreen.

13. The method as claimed in claim 11, wherein at least one key is assigned to a first data set in a data processing system at a first time, and wherein, at a second time subsequent to the first time, the at least one key is assigned to a second data set different from the first data set.

14. The method as claimed in claim 11, wherein at least one input element is assigned to an action of a data processing system.

15. A kit for operating a touchscreen, the kit comprising an input element, the input element comprising:
at least one electrically nonconductive substrate;
at least one electrically conductive layer, wherein the electrically conductive layer is present in structured form on the substrate and comprises at least one key, at least one conductor track and/or at least one electrode, and wherein the at least one electrode and/or the at least one conductor track is operatively connected to the touchscreen; and
a connector adapted to be operatively connected to the touchscreen.

16. The kit as claimed in claim 15, wherein the input element is a first input element, and wherein the kit additionally comprises a second input element and/or a second input device, wherein the second input element or the second input device is connected to the connector.
